(19) United States
(12) Patent Application Publication
(10) Pub. No.: US 2018/0316038 A1
(43) Pub. Date: Nov. 1, 2018

(54) FLOW BATTERY UTILIZING CAUSTIC WASTE

(71) Applicant: QATAR FOUNDATION FOR EDUCATION, SCIENCE AND COMMUNITY DEVELOPMENT, Washington, DC (US)

(72) Inventors: BELABBES MERZOUGUI, DOHA (QA); RACHID ZAFFOU, DOHA (QA)

(73) Assignee: QATAR FOUNDATION FOR EDUCATION, SCIENCE AND COMMUNITY DEVELOPMENT, DOHA (QA)

(21) Appl. No.: 15/766,644

(22) PCT Filed: Oct. 3, 2016
(86) PCT No.: PCT/US2016/055097

§ 371 Date: Apr. 6, 2018

Related U.S. Application Data
(60) Provisional application No. 62/238,686, filed on Oct. 7, 2015.

(51) Int. Cl. H01M 8/20; H01M 8/0234

(52) U.S. Cl. CPC H01M 8/20; H01M 8/0234

(57) ABSTRACT

The flow battery utilizing caustic waste includes at least one battery cell (100), which is formed from an ion-exchange membrane (106) disposed between porous anode and cathode electrode layers (108, 104). A cathode bipolar plate (102) is positioned adjacent the porous cathode electrode layer (104) and, similarly, an anode bipolar plate (110) is positioned adjacent the porous anode electrode layer (108). The anode bipolar plate (110) is adapted for receiving spent caustic waste and transporting the spent caustic waste to the anode electrode layer (108), and the cathode bipolar plate (102) is adapted for receiving an oxidant and transporting the oxidant to the porous cathode electrode layer (104) for generation of electricity while converting the spent caustic waste (303) into fresh caustic (306).

### TECHNICAL FIELD

The present invention relates generally to fuel cells, and particularly to a flow battery that treats caustic waste for recycling while producing electricity therefrom.

### BACKGROUND ART

Spent caustic is an industrial waste caustic solution that has become exhausted and is no longer useful (i.e., “spent”). Spent caustics are typically made of sodium hydroxide or potassium hydroxide, mixed with water and contaminants. In the spent caustic, the contaminants have consumed the majority of the sodium (or potassium) hydroxide, thus the caustic liquor is spent. For example, in one common application H₂S gas is scrubbed by aqueous NaOH solution to form aqueous NaHS, Na₂S, and H₂O, thus consuming the caustic.

Spent caustics are typically malodorous wastewaters that are difficult to treat in conventional wastewater processes. Typically, the material is disposed of by high dilution with bio-treatment, deep well injection, incineration, wet air oxidation, humid peroxide oxidation or other highly specialized processes. Most ethylene spent caustics are disposed of through wet air oxidation.

The treatment and disposal of spent caustic waste is a major concern for the petroleum and gas industry. Currently, electrolysis processes, which are commonly used to treat and dispose of caustic waste, are costly and extremely elaborate on an industrial scale, particularly due to the large amounts of energy required to neutralize the caustic waste. Developing a cost-effective and environmentally friendly process to treat spent caustics would obviously be advantageous.

Thus, a flow battery utilizing caustic waste solving the aforementioned problems is desired.

### DISCLOSURE OF INVENTION

The flow battery utilizing caustic waste includes at least one battery cell, which is formed from a separator (e.g., an ion-exchange membrane) disposed between porous anode and cathode electrode layers. A cathode bipolar plate is positioned adjacent the porous cathode electrode layer and, similarly, an anode bipolar plate is positioned adjacent the porous anode electrode layer. The anode bipolar plate is adapted for receiving spent caustic waste and transporting it to the anode electrode layer, and the cathode bipolar plate is adapted for receiving an oxidant and transporting it to the porous cathode electrode layer for generation of electricity while converting the spent caustic waste into fresh caustic. The ion-exchange membrane may be a polymeric or ceramic membrane, allowing for transport of cations and anions.

When the battery is formed from a plurality of battery cells, the anode and cathode bipolar plates further provide a means to electrically connect the battery cells to generate the required voltage, in addition to providing transport for the reactants. In use, the spent caustic waste is fed to one side of the anode of the battery as a liquid, with the treated/converted waste flowing out the opposite end of the anode. An oxidant, such as air or pure oxygen, is fed to one end of the cathode, with water and redox exiting the other end of the cathode.

The spent caustic waste may include, for example, sulfur containing compounds, oxygen containing compounds, carbon containing compounds, hydrogen containing compounds, sodium hydroxide, potassium hydroxide, sulfides, hydrosulfides, thiols, thiolate of sodium, phenols, quinone derivatives, or may consist of, for example, between approximately 5 wt % and approximately 15 wt % sodium hydroxide, potassium hydroxide or a mixture thereof. The oxidant may be, for example, air, pure oxygen, bromine, hypo chloride or a combination thereof. The oxidant may also be a liquid containing chemical redox, such as, for example, bromine/bromide, iodine/iodide, hypo chloride/chloride, and metal cations M^{+X}/M^{+Y}, where x ranges between 1 and 3 and y ranges between 2 and 5, and the metal cations M are vanadium, manganese, cobalt or nickel.

A mixed potential at an anode side of the at least one battery cell ranges between approximately −0.5 and approximately −0.6 V versus standard hydrogen electrode (SHE), and an open circuit voltage of the at least one battery cell ranges between approximately 0.9 V and 1.2 V. Further, the cathode and anode bipolar plates may be formed from carbon or carbon composites. The anode and the cathode may each further include a catalyst, such as a metal oxide or carbide. The catalyst is preferably both photo-active and electroactive, such as TiO₂, ZrO₂, Nb₂O₅, WC, TiC and mixtures thereof.

These and other features of the present invention will become readily apparent upon further review of the following specification and drawings.

### BRIEF DESCRIPTION OF DRAWINGS

FIG. 1 is a diagram showing a flow battery utilizing caustic waste according to the present invention.

FIG. 2A illustrates an anolyte process (i.e., anode electrochemical reactions) of the flow battery utilizing caustic waste according to the present invention.

FIG. 2B illustrates a catholyte process (i.e., cathode electrochemical reactions) of the flow battery utilizing caustic waste according to the present invention.

FIG. 3 is a process diagram showing the flow battery system utilizing caustic waste according to the present invention.

FIG. 4 diagrammatically illustrates the flow battery stack utilizing caustic waste installed for spent caustic (SC) waste to fresh caustic (FC) conversion and power generation.

Similar reference characters denote corresponding features consistently throughout the attached drawings.

### BEST MODES FOR CARRYING OUT THE INVENTION

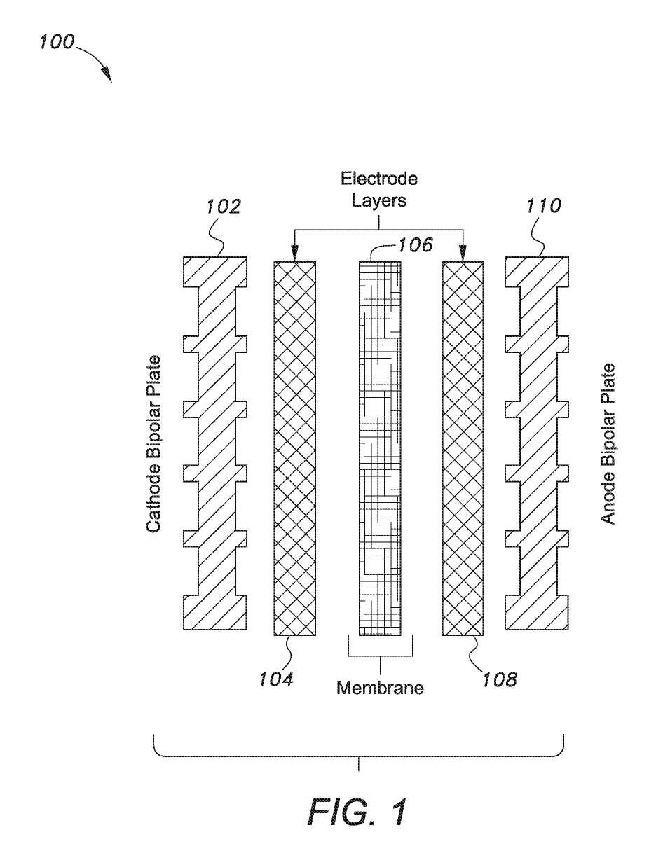

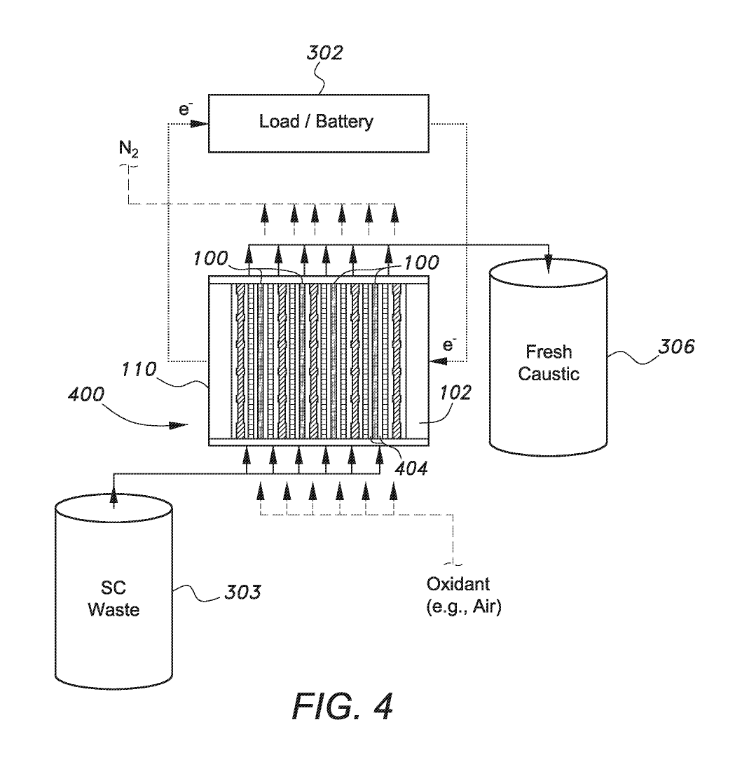

As shown in FIG. 1, a single cell 100 of the flow battery utilizing caustic waste 400 includes electrode layers 104 and 108, with a membrane layer 106 disposed between them. A cathode bipolar plate 102 and an anode bipolar plate 110 are disposed at opposing ends of the battery cell. As shown in FIG. 4, the flow battery utilizing caustic waste 400 may be connected to an external load or battery 302. In FIG. 4, battery 400 is shown as being formed from a plurality of individual cells 100 of the type shown in FIG. 1. Returning to FIG. 1, the membrane layer 106 of each cell 100 is an ion-exchange membrane, which is sandwiched between the electrode layers 104 and 108. Each of electrode layers 104 and 108 are porous. Thus, the combination of membrane 106 and the electrode layers 104 and 108 forms a membrane electrode assembly (MEA).

As shown in FIGS. 1 and 4, flow channels 404 are formed between structures of cells 100, allowing spent caustic waste 303 and an oxidant to circulate through battery 400. The anode bipolar plate 110 is a carbon plate placed in contact with the anode end of the MEA as a means to transport waste to the anode electrode 108. Similarly, the cathode bipolar plate 102 is a carbon plate placed in contact with the cathode end of the MEA as a means to transport air (i.e., the oxidant) or to redox-couple to the cathode electrode 104. In addition to transporting reactants, the bipolar plates 102 and 110 provide a means to electrically connect battery cells 100 to generate the required voltage and current.

It should be understood that the load/battery 302 is shown for exemplary purposes only, and that the load may be any suitable electrical load, including components of the caustic waste system, and excess energy may be supplied to any other suitable type equipment or the electrical grid. The caustic waste to be treated (i.e., spent caustic 303) is fed to one side of the anode of battery 400 as a liquid, with the treated waste flowing out the opposite end of the anode, as illustrated in FIG. 4. An oxidant, such as air and/or redox system, is fed to one end of the cathode, with water and redox exiting the other end of the cathode. Thus, battery 400 is a primary flow battery system that operates on spent caustic waste, such as that generated from gas and oil industrial processes, with the spent caustic waste being used as fuel for the battery 400 to generate power. The battery electrochemical process leading to power generation within the battery stack neutralizes the waste, which then can be disposed of safely. The generated caustic after treatment can be reused again in the process of removing sulfur from the gas stream.

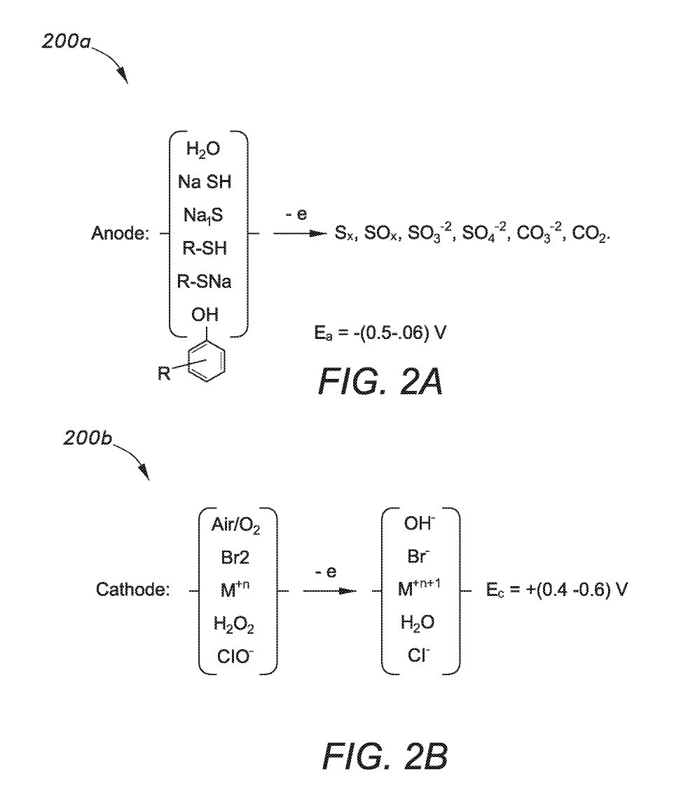

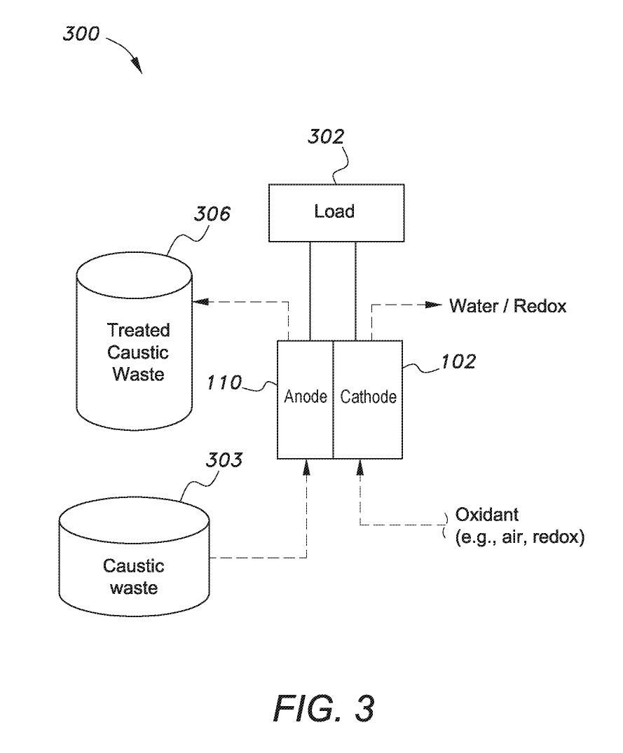

A schematic of the flow battery process 300 is shown in FIG. 3. Operationally, the caustic waste 303, in the form of a liquid, is fed into the anode side of the battery via the anode bipolar plate 110, which contains the flow channels 404 (as shown in FIG. 4). The mixed potential at the anode side of the battery is expected to be in the range of approximately −0.5 to −0.6 V (negative potential) versus standard hydrogen electrode (SHE). An oxidant is supplied at the cathode side to complete the electrical circuit of the battery cell (as described by equations 200a and 200b of FIGS. 2A and 2B, respectively). According to equations 200a and 200b, in the presence of water (H₂O), sodium hydrosulfide (NaSH), sodium sulfide (Na₂S), thiol compounds (R—SH), substituent compounds comprising sodium methanethiolate (R—SNa), and an organic hydroxyl group (R—OH), is caustic waste 303, which may be present at the anode 110. The caustic waste 303 at anode 110 releases negative charge while producing sulfur allotropes (S_{X}), sulfur oxides (SO_{X}), sulfite ions (SO₃⁻²), sulfate ions (SO₄⁻²), carbonate ions (CO₃⁻²)), and carbon dioxide (CO₂), which form the components of treated caustic waste (fresh caustic) 306. Oxygen (O₂) from the air and/or redox, bromine (Br₂), magnesium ions (M⁺ⁿ), hydrogen peroxide (H₂O₂), and hypochlorite ions (ClO⁻) may be used at the cathode 102 and accept a negative charge while producing hydroxides (OH⁻), bromine ions (Br⁻), magnesium ions (M⁺ⁿ, water (H₂O) and chloride ions (Cl⁻), i.e., water/redox. Anode 110 and cathode 102 are connected to and supply electrical power to external load 302.

The oxidant may be air or liquid redox couple with a potential ranging between +0.4 and +0.6 V vs. SHE. As a result, the battery open circuit voltage is expected to be between 0.9 and 1.2 V/cell. Assuming 70% dc-dc battery efficiency, the process can potentially generate between 68 and 162 kJ/mol (H₂S) of energy. It should be noted that anode and cathode potentials depend strongly on the predominant species present in the anolyte and catholyte, respectively. Thus, the open circuit voltage of the cell could be higher than 1.2V.

It is to be understood that the present invention is not limited to the embodiments described above, but encompasses any and all embodiments within the scope of the following claims.

We claim:

1. A flow battery utilizing caustic waste, comprising at least one battery cell including:
porous anode and cathode electrode layers;
an ion-exchange membrane disposed between the porous anode and cathode electrode layers;
a cathode bipolar plate positioned adjacent the porous cathode electrode layer; and
an anode bipolar plate positioned adjacent the porous anode electrode layer;
whereby, the anode bipolar plate is adapted for receiving spent caustic waste and transporting the spent caustic waste to the anode electrode layer, and the cathode bipolar plate is adapted for receiving an oxidant and transporting the oxidant to the porous cathode electrode layer for generation of electricity and conversion of the spent caustic waste into fresh caustic.

2. The flow battery utilizing caustic waste as recited in claim 1, wherein the spent caustic waste is selected from the group consisting of sulfur containing compounds, oxygen containing compounds, carbon containing compounds, hydrogen containing compounds, sodium hydroxide, potassium hydroxide and combinations thereof.

3. The flow battery utilizing caustic waste as recited in claim 1, wherein the spent caustic waste is selected from the group consisting of sulfides, hydrosulfides, thiols, thiolate of sodium, phenols and quinone derivatives.

4. The flow battery utilizing caustic waste as recited in claim 1, wherein the spent caustic waste comprises between approximately 5 wt % and approximately 15 wt % sodium hydroxide.

5. The flow battery utilizing caustic waste as recited in claim 1, wherein the spent caustic waste comprises between approximately 5 wt % and approximately 15 wt % potassium hydroxide.

6. The flow battery utilizing caustic waste as recited in claim 1, wherein the spent caustic waste comprises between approximately 5 wt % and approximately 15 wt % a mixture of sodium hydroxide and potassium hydroxide.

7. The flow battery utilizing caustic waste as recited in claim 1, wherein the oxidant is selected from the group consisting of air, pure oxygen, bromine, hypo chloride and combinations thereof.

8. The flow battery utilizing caustic waste as recited in claim 1, wherein the oxidant is a liquid containing chemical redox.

9. The flow battery utilizing caustic waste as recited in claim 8, wherein the liquid containing chemical redox is selected from the group consisting of bromine/bromide, iodine/iodide, hypo chloride/chloride, and metal cations M^{+X}/M^{+Y}, where x is between 1 and 3 and y is between 2 and 5.

10. The flow battery utilizing caustic waste as recited in claim 9, wherein the metal cations M are selected from the group consisting of vanadium, manganese, cobalt and nickel.

11. The flow battery utilizing caustic waste as recited in claim 1, wherein a mixed potential at an anode side of the at least one battery cell ranges between approximately −0.5 and approximately −0.6 V versus standard hydrogen electrode (SHE).

12. The flow battery utilizing caustic waste as recited in claim 11, wherein an open circuit voltage of the at least one battery cell ranges between approximately 0.9 V and 1.2 V.

13. The flow battery utilizing caustic waste as recited in claim 1, wherein each of said cathode and anode bipolar plates is formed from carbon.

14. A flow battery utilizing caustic waste, comprising a plurality of battery cells, each said battery cell including:
porous anode and cathode electrode layers;
an ion-exchange membrane disposed between the porous anode and cathode electrode layers;
a cathode bipolar plate positioned adjacent the porous cathode electrode layer; and
an anode bipolar plate positioned adjacent the porous anode electrode layer;
whereby, the anode bipolar plate is adapted for receiving spent caustic waste and transporting the spent caustic waste to the anode electrode layer, and the cathode bipolar plate is adapted for receiving an oxidant and transporting the oxidant to the porous cathode electrode layer for generation of electricity and conversion of the spent caustic waste into fresh caustic.

15. The flow battery utilizing caustic waste as recited in claim 14, wherein the anode and the cathode are each formed from a material selected from the group consisting of carbon and composites of carbon and a polymer.

16. The flow battery utilizing caustic waste as recited in claim 15, wherein the anode and the cathode each further comprise a catalyst.

17. The flow battery utilizing caustic waste as recited in claim 16, wherein the catalyst is selected from the group consisting of metal oxides and carbides.

18. The flow battery utilizing caustic waste as recited in claim 17, wherein the catalyst is a photo-active and electroactive material selected from the group consisting of TiO₂, ZrO₂, Nb₂O₅, WC, TiC and mixtures thereof.

19. The flow battery utilizing caustic waste as recited in claim 14, wherein the ion-exchange membrane is a polymeric membrane providing for transport of anions and cations.

20. The flow battery utilizing caustic waste as recited in claim 14, wherein the ion-exchange membrane is a ceramic membrane providing for transport of anions and cations.
